(19) United States
(12) Patent Application Publication
(10) Pub. No.: US 2014/0135089 A1
(43) Pub. Date: May 15, 2014

(54) Modified stud poker game

(71) Applicant: Kathleen Nylund Jackson, Scituate, MA (US)

(72) Inventor: Kathleen Nylund Jackson, Scituate, MA (US)

(73) Assignee: Precedent Gaming, Inc., Scituate, MA (US)

(21) Appl. No.: 13/998,547

(22) Filed: Nov. 8, 2013

Related U.S. Application Data
(60) Provisional application No. 61/796,506, filed on Nov. 13, 2012.

(51) Int. Cl. G07F 17/32

(52) U.S. Cl. CPC G07F 17/3293
USPC 463/13

(57) ABSTRACT

A method of playing a wagering card game on a gaming device comprising at least a processer, input device and video monitor is disclosed. After wagering, three separate hands of cards dealt from a single deck of cards are displayed, each hand consisting of five cards and displayed as having one face-up card and four face-down cards. A separate area for a final five-card hand is also displayed. The player then chooses to play either one, two, or three of the hands. The face-up cards in the chosen hand(s) are transferred to the final hand, and then the face-down cards in those chosen hand(s) are revealed. The most beneficial revealed cards are then added to the face-up cards in the final hand to complete the final hand. Any wins are paid according to predetermined paytables.

### RELATED APPLICATION DATA

This Application claims priority from U.S. Provisional Patent Application Ser. No. 61/796,506, filed Nov. 13, 2012, and having the Title MODIFIED STUD POKER GAME.

### BACKGROUND OF THE INVENTION

1. Field of the Invention

The present invention relates to a poker game suitable for use in casinos and other gaming establishments, as well as wagering or non-wagering space including websites and applications, as an electronic table card game or a video poker game. The invention further relates to casino gaming wherein a game is played upon an apparatus including a processor, input device and monitor and uses a single deck of cards dealt into three 5-card hands, each hand initially revealing only one face-up card.

2. Background of the Art

Games based upon variations of poker have attained enormous popularity as casino-type entertainment games, particularly in the last twenty years. The success of poker games in the gaming industry is partially based on the game's simplicity (i.e., there is widespread public knowledge of the game rules) and the fact that players feel more directly involved in exercising judgment in the play of the game.

Traditional poker as played in card rooms, casinos, and wagering or non-wagering websites allows players to compete head to head against other players. The advent of video technology has also allowed poker games to be played not against other players but against a paytable that determines wins and losses. These games are described as “video poker”.

Video poker may be categorized into two separate game types, draw poker and stud poker. Most video poker games are a variant of draw poker. In draw poker, the player is dealt an initial array of cards. The player chooses to hold or keep none, one, some or all of the cards, the non-chosen cards are discarded, and replacement cards are provided for the discards. The final hand is then analyzed for winning combinations. In stud poker, there is no discard and draw strategy; the player's hand is predetermined on the deal.

Since in virtually every gambling game there is a house advantage (that is, the casino will hold a percentage of the bet, and the player will play the game at less than a 100% payout), it is advantageous for the casino that the more games played per hour, the better. Draw poker, although more engaging in that there is more player involvement, takes more time to play than stud poker, which is quicker to play but less appealing to the discriminating player who likes the challenge of playing a particular strategy.

Certain attempts have been made to create new video poker games in order to stimulate player participation.

U.S. Pat. No. 8,235,781 (Moody) teaches a video poker machine configured to allow a player to play a card game. The video poker machine includes at least one display device, at least one input device, and at least one computer configured to display at least a first hand and a second hand of at least five cards all face up, each hand including the same five cards. A player can be provided an option to play a hand by selecting none, one or more than one of the face up cards from the first hand and the second hand and any additional hands as cards to be held. Each of the cards not selected to be held are discarded from each hand and replaced with a face up card. The player can be provided a pre-established amount based on the amount of a wager made on the hand if the resulting cards of the hand comprise a predetermined poker hand ranking.

U.S. Pat. No. 8,197,321 (Wolf, et al.) teaches a gaming system in which the player is provided a plurality of playing cards to form an initial primary poker hand and one or more other poker hands. The player selects one or more of the initially dealt cards in the primary poker hand to hold or to discard. The held cards are also held in one, more or each of the other simultaneously displayed hands. The gaming device evaluates the held cards and determines which poker game outcomes are possible based on the held cards and the remaining cards in the deck. The gaming device utilizes a stored table of different distributions of poker game outcomes which would result in each payout amount and a table regarding which poker game outcomes are possible based on the player's held cards to determine a distribution of outcomes that provides a total payout equal to the payout of the predetermined game outcome.

U.S. Pat. No. 8,182,324 (Stone) teaches a method for providing a payout based on a scattered combination of game cards. A plurality of hands of cards is displayed, including at least a first hand of cards and a second hand of cards. Each hand of cards includes one or more card positions. In each hand of cards, a card is placed in each of the one or more card positions. Characteristics associated with each card in the each displayed hand of cards are analyzed. A first card in a first card position in the first hand of cards is combined with a second card in the second hand of cards. A determination is made whether a winning combination of cards is formed by at least the first and second cards in the first and second hands of cards. A payout award is provided based on the winning combination of cards.

U.S. Pat. No. 7,963,837 (Moody) discloses a stud poker game in which a partial hand of cards is dealt as the player's hand. The player is then permitted to choose one of the undealt cards to be added to the player's hand. The remaining cards needed to complete the player's final hand are dealt. If the player has achieved a winning card combination on his final hand, the player receives an award. The award is based on the poker hand ranking of the final player's hand and the amount wagered by the player.

U.S. Pat. No. 7,785,182 (Thomas, et al.) teaches a method of playing a card-based wagering game. The method comprises conducting the card-based wagering game at a gaming terminal and displaying a plurality of cards arranged in an array. The plurality of cards includes a first set of selectable cards and a first set of non-selectable cards. The non-selectable cards are at least partially protected by others of the plurality of cards. One or more of the selectable cards are selected. A player's hand is created by removing the selected cards from the array, which then creates a second set of selectable cards and a second set of non-selectable cards in the array such that the second set of non-selectable cards are at least partially protected by others of the plurality of cards. It is then determined whether the player's hand is a winning hand.

U.S. Pat. No. 7,727,061 (Taylor) teaches a method for playing video gambling games whereby pay tables vary from play to play, or, alternatively, whereby a plurality of pay tables are possible within a game. For example, in a video poker game a player wagers against a first pay table. If a winner occurs, the next game offers a new pay table with a greater expected value. This process continues until the player loses, whereupon the player is returned to play against the first pay table. Pay tables increment and decrement in expected value based on achieving predetermined events within the current game, within a previous game or games or randomly.

U.S. Pat. Nos. 7,431,644 and 7,404,762 (Moody) describe a video poker machine that is configured to allow a player to play a card game. The video poker machine includes at least one display device, at least one input device, and at least one computer configured to display at least a first hand and a second hand of at least five cards all face up, each hand including the same five cards. A player can be provided an option to play a hand by selecting none, one or more than one of the face up cards from the first hand and the second hand and any additional hands as cards to be held. Each of the cards not selected to be held are discarded from each hand and replaced with a face up card. The player can be provided a pre-established amount based on the amount of a wager made on the hand if the resulting cards of the hand comprise a predetermined poker hand ranking.

U.S. Pat. Nos. 7,222,858 and 7,222,857 (Moody) teach a video poker game in which after a wager is made on at least one hand of cards, at least five cards are selected from at least one deck of cards, and all are displayed face up. The deck of cards includes a plurality of cards each having a rank and a suit. At least two of the ranks are different and at least two of the suits are different. Zero, one or a plurality of the cards are selected from the first hand as cards to be held. If a second wager is made on a second hand, a card having the same rank as the card selected to be held from the first hand is displayed in the second hand for each card selected to be held from the first hand. The first and second hands can be completed to include at least five face up cards. Any awards for any determined winning combinations of cards of the completed first or second hands can be displayed.

U.S. Pat. No. 7,137,628 (Moody, et al.) teaches a method of playing a draw poker game by a single player only. The player makes a wager for each separate hand to be played. At least two hands of five cards are dealt all face up from a standard deck of playing cards. The cards in the first hand are the same cards as the cards in the second hand. The player discards none, one or more cards from the first hand. The player discards none, one or more cards from the second hand. Cards that have been discarded in each hand are replaced by cards from the standard deck of playing cards. The poker hand ranking of each hand is determined. The player is paid for any winning poker hands based on a pay table and the amount of the player's wager.

U.S. Pat. No. 7,037,190 (Moody, et al.) teaches a stud poker game in which a plurality of initial partial hands are displayed to the player. Each initial partial hand has the same cards with the cards displayed face up to the player. Each hand is then completed as a stud poker final hand. The player wins or loses depending on the poker hand ranking of each final hand. If the player achieves two or more final hands of the same poker hand ranking, the amount won by the player is increased, preferably as multiples of the original payout amounts.

U.S. Pat. Nos. 6,964,418, 6,955,356 and 6,877,747 (Moody) disclose a video poker game in which a player makes a wager to play a draw poker game and a wager to play a stud poker game which is allocated over one or more stud poker hands. The player is dealt a draw poker hand. The player is then dealt one or more stud poker hands depending on the number of stud poker hands selected to be played. The player wins or loses depending on the poker hand ranking of each of the stud poker hands. The amount won for each winning hand is based on the poker hand ranking and the amount wagered according to a stud poker pay table. The player plays out the draw poker hand in accordance with the conventional manner of play of draw poker. The amount won for each winning hand is based on the poker hand ranking and the amount wagered according to a draw poker pay table.

U.S. Pat. No. 6,638,163 (Moody) discloses a video poker game in which the player makes a wager and is dealt a five card poker hand. The player wins or loses depending on the poker hand ranking of the hand. If the player has achieved a winning poker hand combination, the player is paid according to the pay table and the player plays again for no additional wager. The player is dealt a new five card hand and the poker hand ranking of this new five card is determined. If the player has a losing hand, the game is over. If the player has a winning hand, the player is paid according to the pay table and the player receives yet another five card for no additional wager. This continues until the player receives a losing hand. The method of play can also be applied to multiple hands.

U.S. Pat. No. 6,561,898 (Moody) discloses an invention that is a stud poker game wherein the player makes a wager that is allocated among the number of hands that the player selects to play. Once the player has made his wager, a plurality of initial partial hands are displayed to the player. Each initial partial hand has the same cards with the cards displayed face up to the player. The player is then provided with the opportunity to increase or decrease his wager on each hand before the hand is completed. Each hand is then completed as a stud poker final hand by dealing the additional cards. The player wins or loses depending on the poker hand ranking of each final hand.

U.S. Pat. Nos. 6,129,357 and 6,048,267 (Wichinsky) describe a card game in which the player wagers on one or multiple hands that the player wishes to play. Using a separate deck of standard playing cards for each hand, three cards are dealt face up to each of the player hands. Using the deck of playing cards that corresponds to that hand, two cards are then dealt—one face up and one face down—to be used as cards that can be selected by the player for use in the player's hand. The player selects either the face up card or the face down card. The selected card is added to the player's hand as the fourth card and is displayed face up. The unselected card is then discarded. Two more cards are dealt, again using the deck of playing cards that corresponds to that hand, one card face up and one card face down. The player again selects either the face up card or the face down card. The selected card is added to the player's hand as the fifth card and is displayed face up with the unselected card being discarded. This results in the player having multiple complete five card hands. Each of the resulting five card hands are analyzed to determine its poker hand ranking. The amount won by the player is based on the amount wagered by the player. A payout schedule is provided with the highest hand being a Royal Flush.

U.S. Pat. No. 6,007,066 (Moody) discloses an invention that involves a card game in which at least two rows of cards, and preferably three rows, are dealt to a player. The player makes a wager for each row of cards. All three rows of cards are dealt face up with each row having the same cards by rank and suit. The player selects none, one or more of the face up cards from one of the rows as cards to be held. The cards that are held are also held in all of the other rows. Replacement cards for the non-selected cards are dealt into each row. The poker hand ranking of each five card hand by row is determined. The player is then paid for any winning poker hands based on a pay table and the amount of the player's wager.

U.S. Pat. Nos. 5,100,137 and 5,167,413 (Moody) discloses an invention that involves a card game known as DOUBLE DOWN STUD poker, in which the player makes a first wager and is dealt four cards all face up. The player may make an additional wager prior to receiving the fifth card. After the fifth card is dealt, the five card hand is compared to a pay table to determine if the player has a winning or losing card combination based on poker hand ranking.

U.S. Patent Application No. 20120122534 (Montross, et al.) describes an interactive poker game that provides a predetermined outcome to a player. The gaming device determines, based on an obtained predetermined game outcome, one or more playing cards to display for one or more individual hands of playing cards. The gaming device then enables the player to select one of the individual poker hands to actively play. The gaming device determines which playing cards must be provided to the actively played poker hand to provide the player the predetermined game outcome. The active poker hand is provided any determined cards which when combined with any previously revealed playing cards results in a poker hand with an associated payout equal to the payout associated with the predetermined game outcome. The gaming device determines and displays one or more playing cards for each of the non-selected hands of playing cards and provides the predetermined game outcome to the player.

U.S. Patent Application No. 20110092263 (Naicker) teaches an interactive poker game in which a player of a card game, such as poker, may be presented with opportunities to replace one or more of the cards in his or her hand. For example, the player may be dealt a first set of cards, and then offered a first opportunity to replace one or more cards in the first set. The player may also be dealt a second set of cards, and then offered a second opportunity to replace one or more cards in the second set. Preferably, the first set and the second set of cards, when combined, form the player's hand of cards. The player may accept at least one of these two offers and, in doing so, may incur a cost for accepting one or more of the offers. This cost may be based on the difference between a first return associated with hand of cards played without replacement, and an expected second return associated with the offer(s) the player accepted.

U.S. Patent Application No. 20080194308 (Falciglia) describes a system and method for playing a card game that includes dealing first and second hands. The first hand of cards is dealt all face up from at least one deck of cards. The second hand of cards is also dealt all face up from the at least one deck of cards. Each of the cards of the second hand corresponds to a card of the first hand forming a plurality of corresponding pairs of cards. The system and method can provide a player with at least one strategy for selection. The at least one strategy for selection can include a winning hand selection, a pair selection, a two-pair selection, a straight draw selection, a flush draw selection, a straight flush draw selection, a royal flush draw selection, a best choice selection, a prospect choice selection, and/or a player choice selection. The system and method can also automatically select in accordance with the selected strategy from each of the corresponding pairs of cards of the plurality of corresponding pairs of cards one of the corresponding card of the first hand, the corresponding card of the second hand, and no card for duplicating to a respective position of at least one sub-hand.

U.S. Patent Application No. 20080188278 (Paulsen, et al.) describes a gaming device that includes a plurality of sets of interactive player-selectable symbols which are sequentially offered to a player during a game played upon the gaming device. The player may select one or more of the player-selectable symbols to be added to one or more sets of symbols which were initially provided to the player. In one embodiment of the invention, the interactive player-selectable symbols are gaming cards for a conventional deck of playing cards offered to the player in a video draw poker game. The gaming device enables a player to play a single-hand poker game or a multi-hand poker game. In one embodiment, the processor determines a number of initial cards in a hand and provides or deals the player the initial cards. The number of initial cards is less than the number of cards required for a complete hand in the poker game. In most conventional video draw poker games, five cards are needed for a complete poker hand. The processor determines the cards in an offer set of cards, offers the offer set to the player, and enables the player to select one or more of the cards in the offer set of cards. The processor adds the player-selected cards from the offer set to the hand with the initial cards to form a complete hand. If the cards in the complete hand after the addition of the player-selected cards includes a predetermined winning hand, the processor provides the player with an award.

U.S. Patent Application No. 20080102913 (Schultz) teaches a game and method for a game including a stud poker feature game. The game includes an interface activatable by a player and a primary game having a set of outcomes, at least one of the set of outcomes determined after activation of the interface by the player. The game further includes a feature game having one or more hands of poker dealt to the player, each hand including at least one card, wherein none of the cards may be discarded or replaced by the player. The feature game is initiated upon the occurrence of a triggering event.

U.S. Patent Application No. 20060157936 (Moody) teaches a game and method for a game in which a player makes a wager which is allocated among a plurality of stud poker hands to be played by the player. One of the wagers is allocated to a full hand of cards and the other wagers are allocated among poker hands that are comprised of various subsets of the full hand. The player is then dealt the full hand of cards. The player wins or loses depending on the stud poker hand ranking of the full hand. The various subsets of hands are then analyzed to determine whether there are any winning hand combinations among the subset of hands. Awards for winning hand combinations are 11 made to the player based on the poker hand ranking of each subset hand and the full hand according to a pay table and the amount wagered by the player on each subset hand and the full hand.

U.S. Patent Application No. 20030162577 (Hamud) teaches a “player's hand only” format video poker game in which a wager causes the gaming machine to deal and display a video image of two five card stud poker hands from a standard deck of fifty-two cards, all face up. The player may win on one or both hands per a pre-established poker hand ranking paytable, the amount won based the hand ranking and the amount wagered. If, however, the player has a threshold hand, be it only a pair in either or both hands, and nothing else, (as determined by the variation of the game played), then, the player is allowed to and does play all ten cards on the screen as a single, Super Stud hand, winning any of the pre-established poker hand rankings in the Super Stud paytable. In this game, the pair is the threshold hand. In other variations, it could be only some but not all pairs, and/or hands wherein there were no winners or pairs at all (losing hands).

U.S. Patent Application No. 20020185814 (Moody) describes a video poker game in which a player selects the number of hands that the player wishes to play. A plurality of initial partial hands are displayed to the player. Each initial partial hand has the same cards with the cards displayed face up to the player. Each hand is then completed as a stud poker final hand by dealing the additional cards from either the original single deck of cards (less the initially dealt cards) or from a plurality of partial depleted decks of playing cards, each depleted deck of playing cards comprising a full deck less the cards dealt as the initial partial hand. The player wins or loses depending on the poker hand ranking of each final hand. The amount won by the player is based on the poker hand ranking of each final hand and the amount wagered by the player according to a pay table.

Each of the references discussed in this text art are incorporated herein in their entirety for all purposes.

It is an ever-increasing challenge to provide players with new and enticing gameplay features that will stimulate player interest and increase time at the table or the machine. It would be advantageous to combine a video stud poker game with certain aspects of a draw poker game so that the player is offered a quick and compelling card game that allows the player a fast and simple decision-making process that provides excitement and anticipation.

### SUMMARY OF THE INVENTION

A method of playing a wagering card game on a gaming device comprising at least a processer, input device and video monitor screen. After a wager is made, three separate hands of cards dealt from a single deck of cards are displayed on the screen, each hand consisting of five cards, with one face-up card and four face-down cards in each hand. A separate area for a final 5-card hand is also displayed. The player is prompted to choose to play either one, two, or three of the hands to initially populate the final hand. If the player chooses only one of the hands, the up card in that hand is transferred face up to the final hand. The four face-down cards in that chosen hand are then revealed and transferred face up to the final hand, and the final 5-card hand is analyzed for any wins. If the player chooses any two hands, the two up cards in those hands are transferred face up to the final hand. The eight face-down cards in those chosen hands are then revealed and the three most beneficial cards (based on the optimum expected value) are transferred face up to the final hand, and the final 5-card hand is analyzed for any wins. If the player chooses all three hands, the three up cards in those hands are transferred face up to the final hand. The twelve face-down cards in those chosen hands are then revealed and the two most beneficial cards (based on the optimum expected value) are transferred face up to the final hand, and the final 5-card hand is analyzed for any wins. Wins are paid according to predetermined paytables, the paytables being based on the amount of hands that the player chose to play.

### BRIEF DESCRIPTION OF THE FIGURES

FIG. 1 shows an electronic screen utilizing the game technology described herein, and providing the basic elements of the game.

FIG. 2 shows a first game of the present technology wherein the player has placed his bet, and three hands of cards are dealt.

FIG. 3 shows the first game wherein the player chooses the hands to play, and the up cards being transferred to the final hand.

FIG. 4 shows the first game at a later stage, with the down cards being revealed.

FIG. 5 shows the first game at a later stage, wherein the most optimal revealed cards are transferred to the final hand.

FIG. 6 shows the first game at a resolution stage.

FIG. 7 shows a second game of the present technology wherein the player has placed his bet, and three hands of cards are dealt.

FIG. 8 shows the second game at a later stage wherein the player chooses the hands to play, and the up cards being transferred to the final hand.

FIG. 9 shows the second game at a later stage, wherein the down cards are revealed and the most optimal revealed cards are transferred to the final hand.

FIG. 10 shows the second game at a resolution stage.

FIG. 11 shows a third game of the present technology wherein the player has placed his bet, and three hands of cards are dealt.

FIG. 12 shows the third game at a later stage wherein the player chooses the hands to play, and the up cards being transferred to the final hand.

FIG. 13 shows the third game at a later stage, with the down cards being revealed.

FIG. 14 shows the third game at a later stage, wherein the most optimal revealed cards are transferred to the final hand.

FIG. 15 shows the third game at a resolution stage.

### DETAILED DESCRIPTION OF THE INVENTION

A method of playing an electronic card game uses one deck of 52 standard playing cards having traditional symbols and rank. Alternately the deck may or may not contain additional cards such as Jokers or Wild Cards. The game is played utilizing at least a computer processor, input device and a video monitor screen. The game may be played at least on a casino gaming machine, an electronic table, an internet gaming site, or as a mobile application.

The card game is basically a stud poker game, modified to include a simple decision-making element that provides an extra excitement and anticipation not seen in traditional stud poker. The gameplay, like any stud poker, does not allow for discarding and drawing replacement cards for the discarded cards, yet the decision-making element allows for a game that requires a knowledge of basic strategy in order to receive the highest awards: It is this type of challenge in video poker that first attracts the player, and then keeps him playing.

The game (herein known as “1-2-3 Stud Poker”) begins with a wager being placed on a player input device in order to play. The wager may be in credits or cash. Alternately, the game may be played in a non-wagering environment and may require non-monetary tokens, vouchers or the like in order to play. The player is then dealt three separate playable hands of cards from the single deck of cards that are displayed on the screen. Each playable hand consists of five cards, with one face-up card and four face-down cards in each hand. Additionally, a separate area for a final 5-card hand is displayed. Also shown on the screen are three separate paytables: one paytable for choosing to play any one single hand, a second and different paytable for choosing to play any two hands, and a third and different paytable for choosing to play all three hands.

The player is then prompted to choose to play either one, two, or three of the playable hands to complete the final hand. That decision to choose hands is based on the makeup of the three face-up cards (one in each of the three hands) and will affect the outcome of the game. Because cards are required to be dealt from a randomly shuffled 52-card deck (or more cards, in the case of Wild Card games), the possible combinations are known, the frequency of the combinations can be calculated, and an optimal playing strategy can be devised. If the player chooses to play only one of the hands, the up card in that hand is transferred face up to the final hand. (Each reference of “transferring” incorporated herein may also mean “replicating”; i.e., chosen cards may be transferred to the final hand, leaving the initial card position blank, or replicated, keeping the card in its initial position as well as being transferred to the final hand. In either case, the cards chosen by the player will appear in the final hand.) The four face-down cards in that chosen hand are then revealed and transferred face up to the final hand, and the final 5-card hand is analyzed for any wins. If the player chooses to play any two hands, the two up cards in those hands are transferred face up to the final hand. The eight face-down cards in those chosen hands are then revealed and the three most beneficial cards (based on the optimum expected value) are transferred face up to the final hand, and the final 5-card hand is analyzed for any wins. If the player chooses to play all three hands, the three up cards in those hands are transferred face up to the final hand. The twelve face-down cards in those chosen hands are then revealed and the two most beneficial cards (based on the optimum expected value) are transferred face up to the final hand, and the final 5-card hand is analyzed for any wins.

Wins are paid according to predetermined paytables, the paytables being based on the amount of hands that the player chose to play. The paytable for one hand being played provides higher pays than the paytable for two hands being played, which in turn provides higher pays than the paytable for three hands being played. For example, a straight flush attained as a win with one hand being played may pay 10000 credits. A straight flush attained as a win with two hands being played may pay 300 credits. A straight flush attained as a win with three hands being played may pay 250 credits.

Illustrated below are three different sample paytables for a single game play, based on a bet of 15 credits per game.

### 1-2-3 STUD POKER

### PLAY 1 HAND

### SAMPLE PAYTABLE:

Jacks or Better—30-for-15
2 Pairs—65-for-15
3-of-a-Kind—125-for-15
Straight—250-for-15
Flush—300-for-15
Full House—500-for-15
4-of-a-Kind—2000-for-15
Straight Flush—10000-for-15
Royal Flush—50000-for-15

### PLAY 2 HANDS

### SAMPLE PAYTABLE:

Jacks or Better—5-for-15
2 Pairs—10-for-15
3-of-a-Kind—10-for-15
Straight—15-for-15
Flush—20-for-15
Full House—30-for-15
4-of-a-Kind—75-for-15
Straight Flush—300-for-15
Royal Flush—5000-for-15

### PLAY 3 HANDS

### SAMPLE PAYTABLE:

Jacks or Better—5-for-15
2 Pairs—5-for-15
3-of-a-Kind—10-for-15
Straight—10-for-15
Flush—15-for-15
Full House—20-for-15
4-of-a-Kind—75-for-15
   Straight Flush—250-for-15
   Royal Flush—2500-for-15

Reference to the Figures will assist in further understanding of the practice of the present invention.

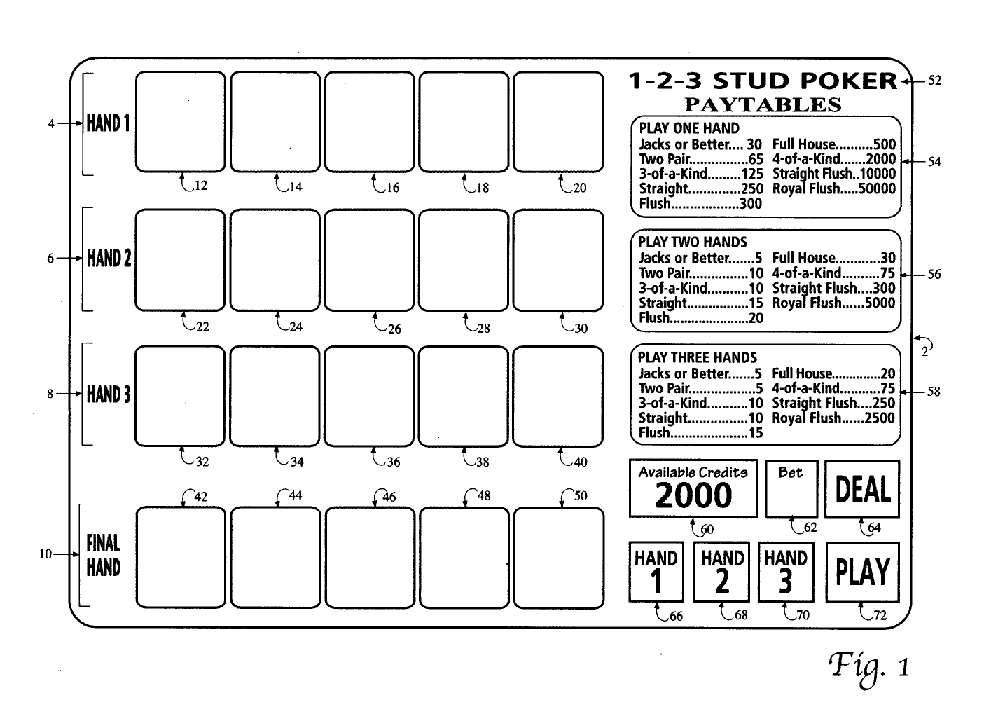

FIG. 1 illustrates an electronic screen 2 depicting the basic elements of the present invention. An area for the first dealt hand 4 is shown, including an area for the first card 12, an area for the second card 14, an area for the third card 16, an area for the fourth card 18, and an area for the fifth card 20. An area for the second dealt hand 6 is shown, including an area for the first card 22, an area for the second card 24, an area for the third card 26, an area for the fourth card 28, and an area for the fifth card 30. An area for the third dealt hand 8 is shown, including an area for the first card 32, an area for the second card 34, an area for the third card 36, an area for the fourth card 38, and an area for the fifth card 40. An area for the final hand 10 is shown, including an area for the first card 42, an area for the second card 44, an area for the third card 46, an area for the fourth card 48, and an area for the fifth card 50. The name of the game 52 is shown. Also shown is a paytable 54 for playing any one hand, a paytable 56 for playing any two hands, and a paytable 58 for playing all three hands. The player's available credits (2000) 60 is shown, as well as an area for the player to bet or wager by pressing the touchscreen button 62. A touchscreen Deal button 64 allowing the player to lock in his bet and have the cards dealt is shown. Three additional touchscreen buttons are shown, allowing the player to choose to play either any one hand 66, any two hands 68, or all three hands 70. A play touchscreen button 72 is also shown. It should be appreciated that physical buttons, keyboard buttons, a mouse or any other like tool may be utilized instead of the touchscreen buttons in order to enable the player make his choice(s).

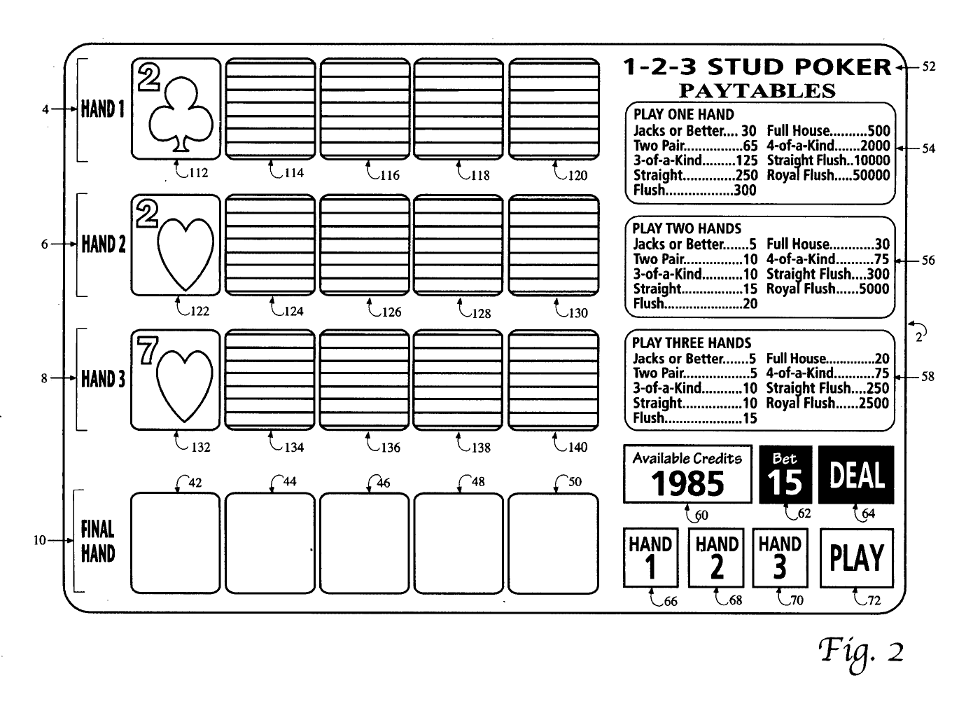

FIG. 2 refers to the elements in FIG. 1 with the player choosing to wager 15 credits 62 and pressing deal 64 in order to play the game. (Player choices are depicted as white type on black.) The player's available credits have now been decremented to 1985 credits 60. Three 5-card hands are then dealt: Hand 1 comprises a first face-up card, the 2 of Clubs 112, and four face-down cards (114, 116, 118, 120). (Face-down cards are depicted by horizontal lines.) Hand 2 comprises a first face-up card, the 2 of Hearts 122, and four face-down cards (124, 126, 128, 130). Hand 3 comprises a first face-up card, the 7 of Hearts 132, and four face-down cards (134, 136, 138, 140).

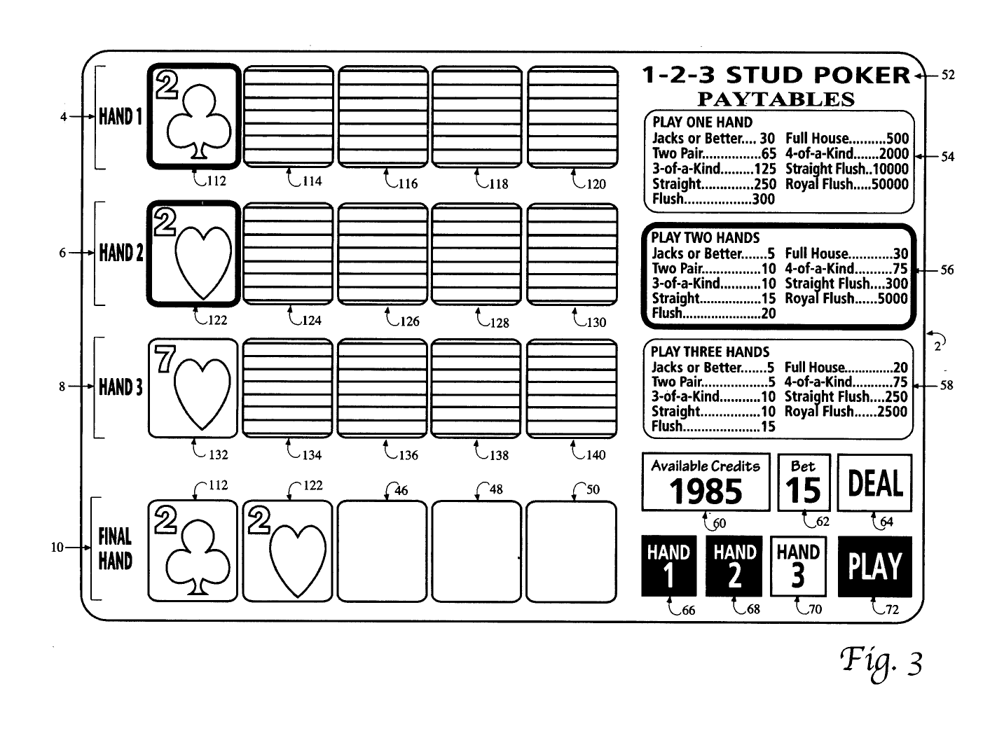

FIG. 3 refers to the elements in FIG. 2 with the player electing to play Hand 1 66 and Hand 2 68, and pressing the Play button 72 to lock in his choice. Since the up cards in the selected hands provide a Pair of 2s, the player is hoping that the final hand may result in a winning hand of at least 2 Pairs. The up card 112 in Hand 1 is then transferred to the final hand 10. The up card 122 in Hand 2 is also transferred to the final hand. The paytable for playing two hands 56 is then highlighted.

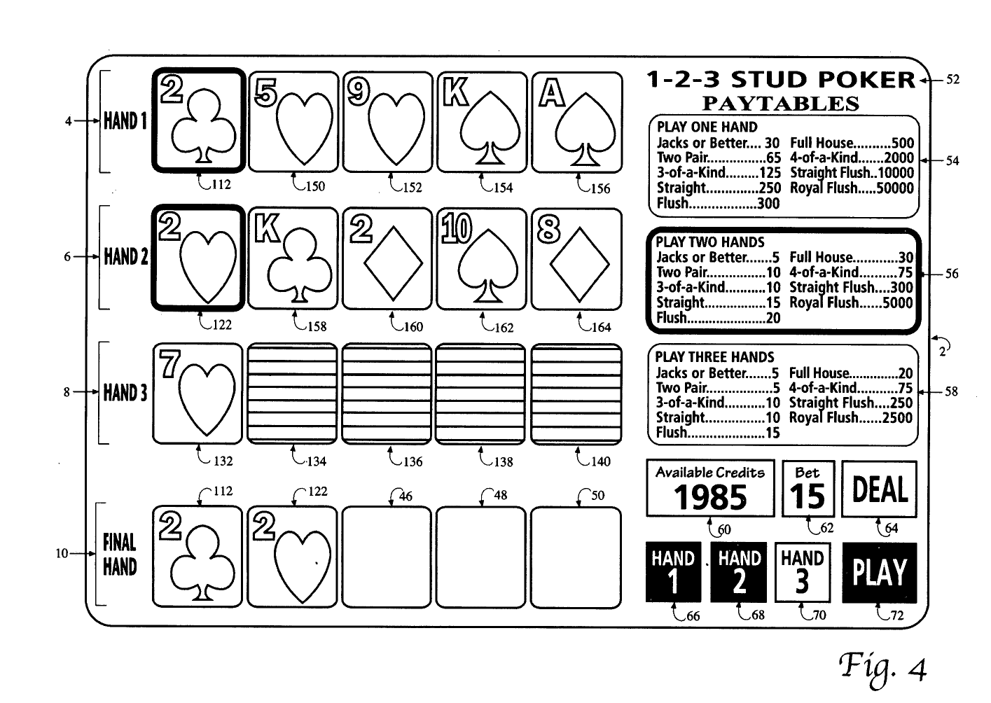

FIG. 4 refers to the elements in FIG. 3, with the face-down cards in Hand 1 being revealed (150, 152, 154, 156) and the face-down cards in Hand 2 being revealed (158, 160, 162, 164).

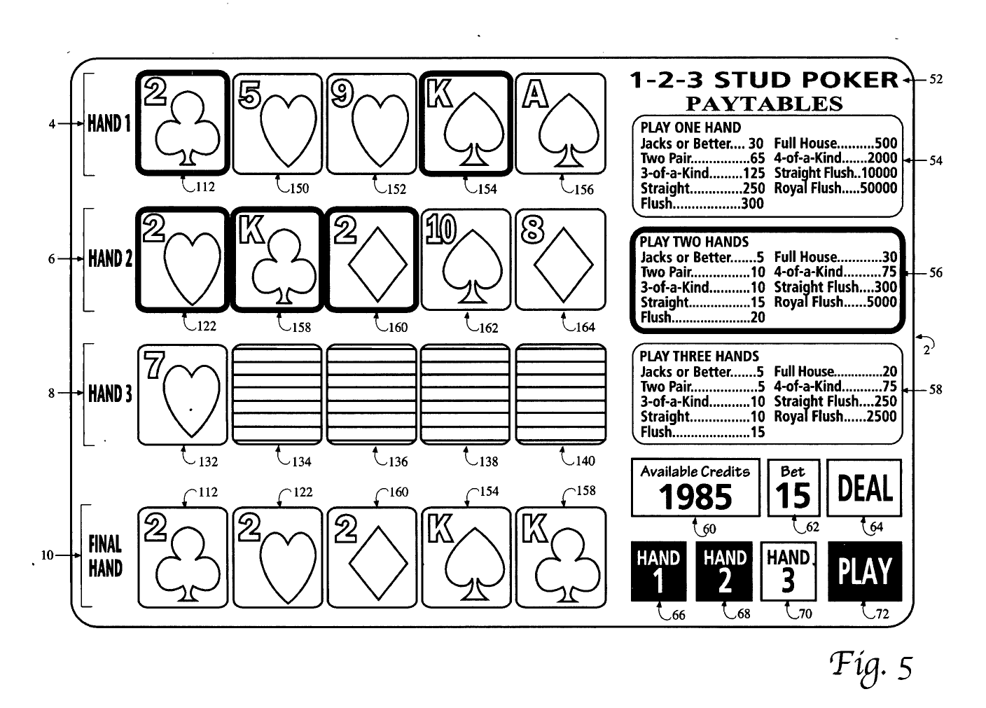

FIG. 5 refers to the elements in FIG. 4, with the three most optimal cards to complete the final hand being highlighted: the 2 of Diamonds 160, the King of Spades 154 and the King of Clubs 158. These same three cards are then transferred to the final hand.

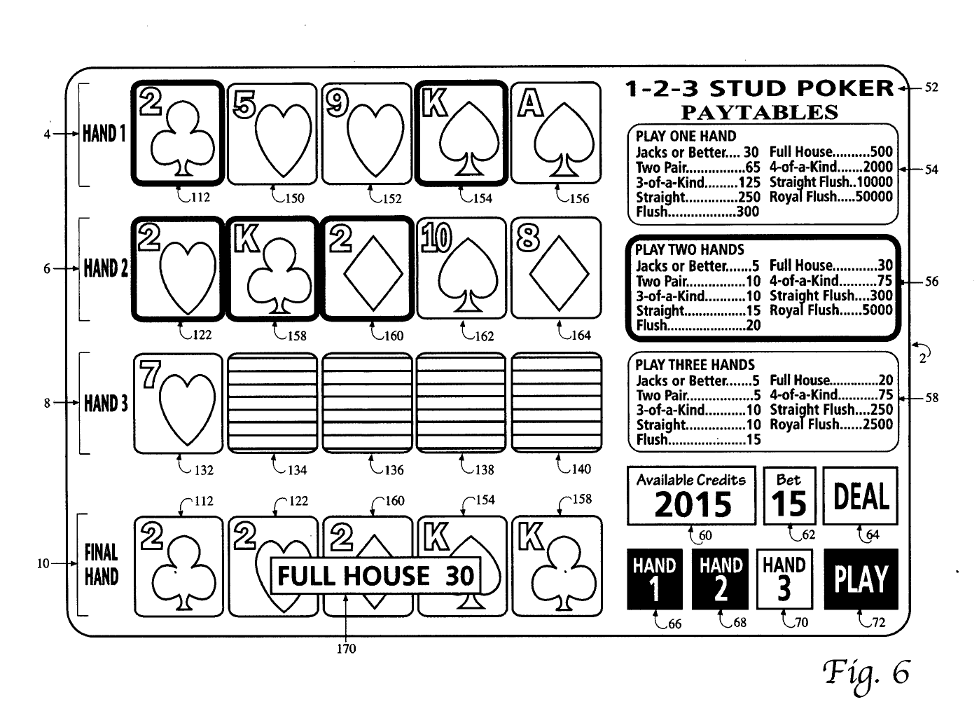

FIG. 6 refers to the elements in FIG. 5 with the final hand comprising a full house of three 2s and two Kings (112, 122, 160, 154, 158). According to the highlighted paytable 56, the final hand is worth 30 credits, as is shown in area 170. The 30 credits are then added to the player's available credits 60, now shown as 2015 credits.

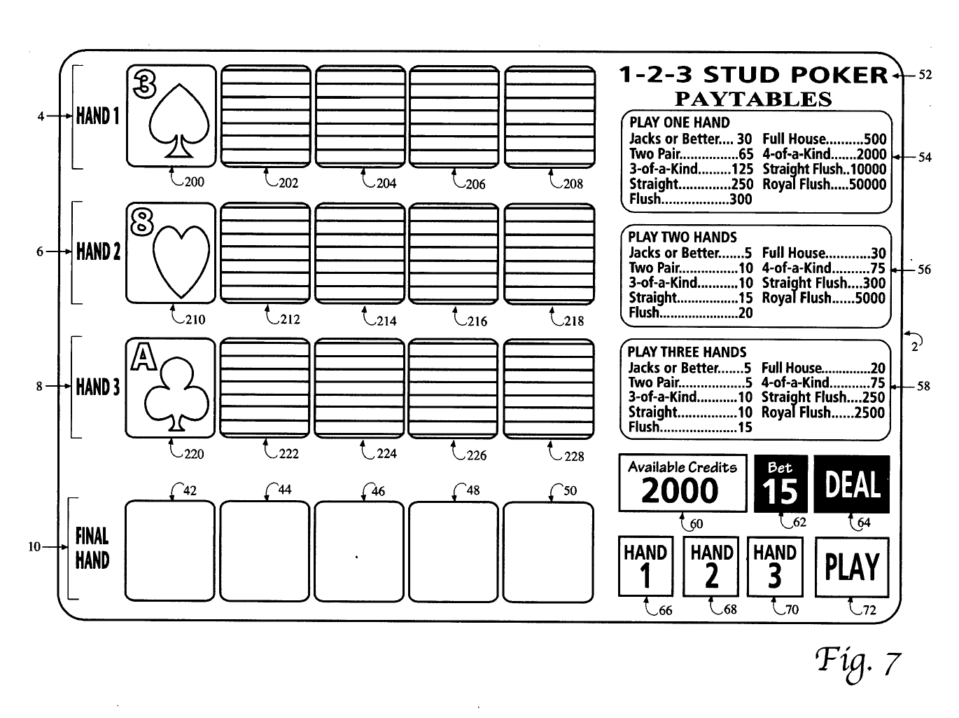

FIG. 7 refers to the elements in FIG. 1 with the available credits of FIG. 6, with the player wagering 15 credits 62 and pressing deal 64 in order to play a separate subsequent game. The player's available credits have now been decremented to 2000 credits 60. Three 5-card hands are then dealt: Hand 1 comprises a first face-up card, the 3 of Spades 200, and four face-down cards (202, 204, 206, 208). Hand 2 comprises a first face-up card, the 8 of Hearts 210, and four face-down cards (212, 214, 216, 218). Hand 3 comprises a first face-up card, the Ace of Clubs 220, and four face-down cards (222, 224, 226, 228).

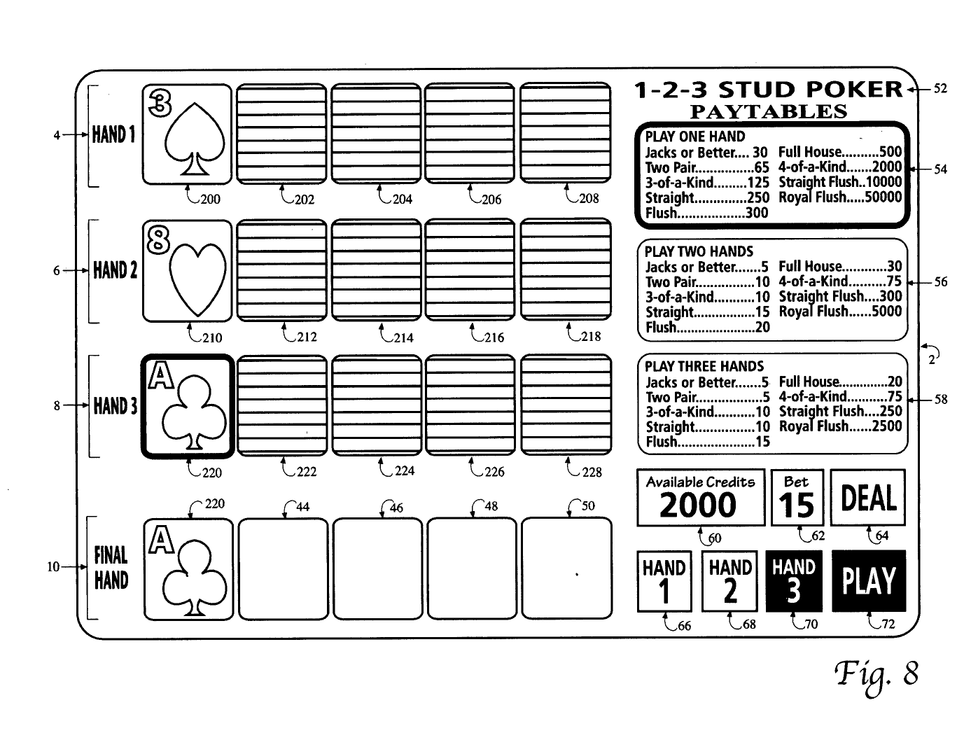

FIG. 8 refers to the elements in FIG. 7 with the player electing to play Hand 3 70, and pressing the Play button 72 to lock in his choice. Since the up card in the selected hand provides an Ace, the player is hoping that the final hand may result in a winning hand of at least Jacks or Better. The up card 220 in Hand 3 is then transferred to the final hand 10. The paytable for playing one hand 54 is then highlighted.

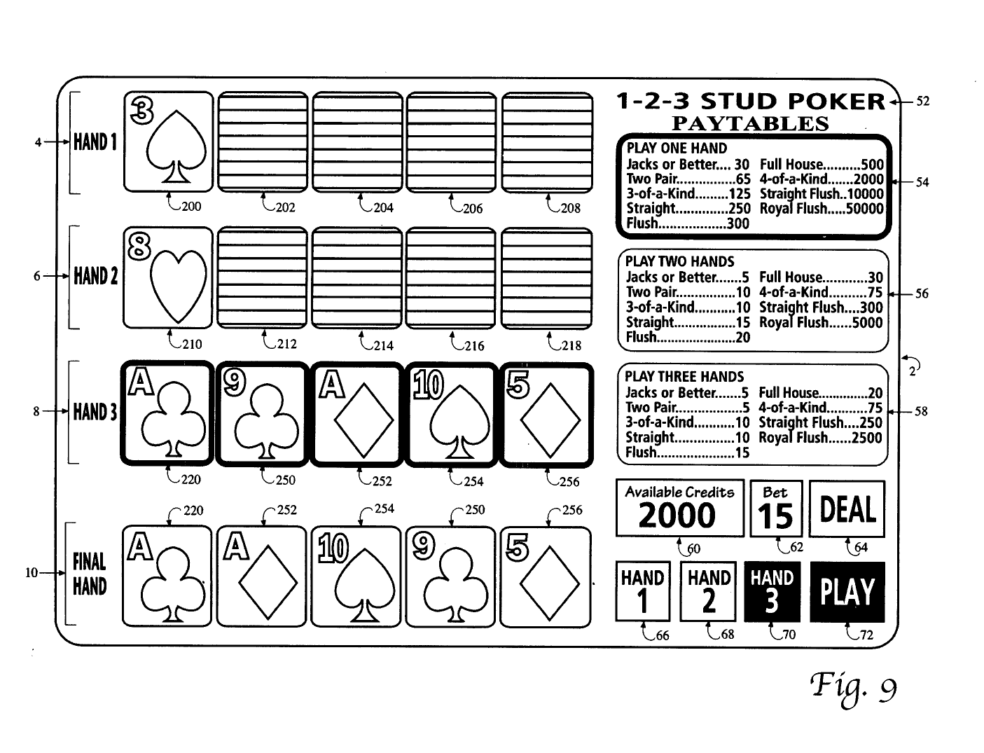

FIG. 9 refers to the elements in FIG. 8, with the face-down cards in Hand 3 being revealed (250, 252, 254, 256) and then transferred to the final hand 10.

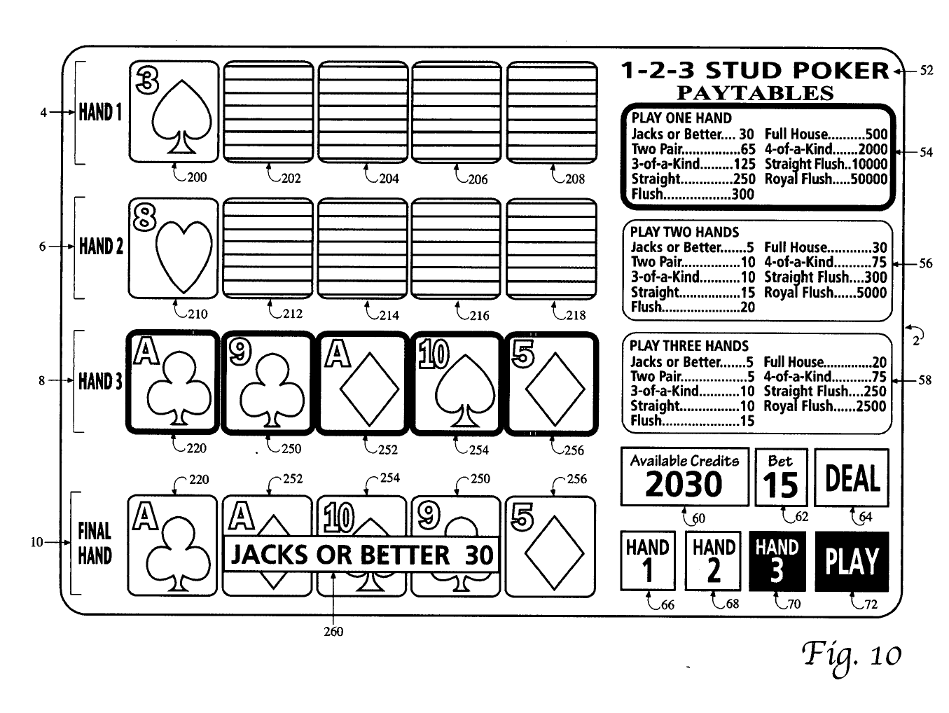

FIG. 10 refers to the elements in FIG. 9, with the final hand comprising two Aces 220 and 252, or a pay of Jacks or Better. According to the highlighted paytable 54, the final hand is worth 30 credits, as is shown in area 260. The 30 credits are then added to the player's available credits 60, now shown as 2030 credits.

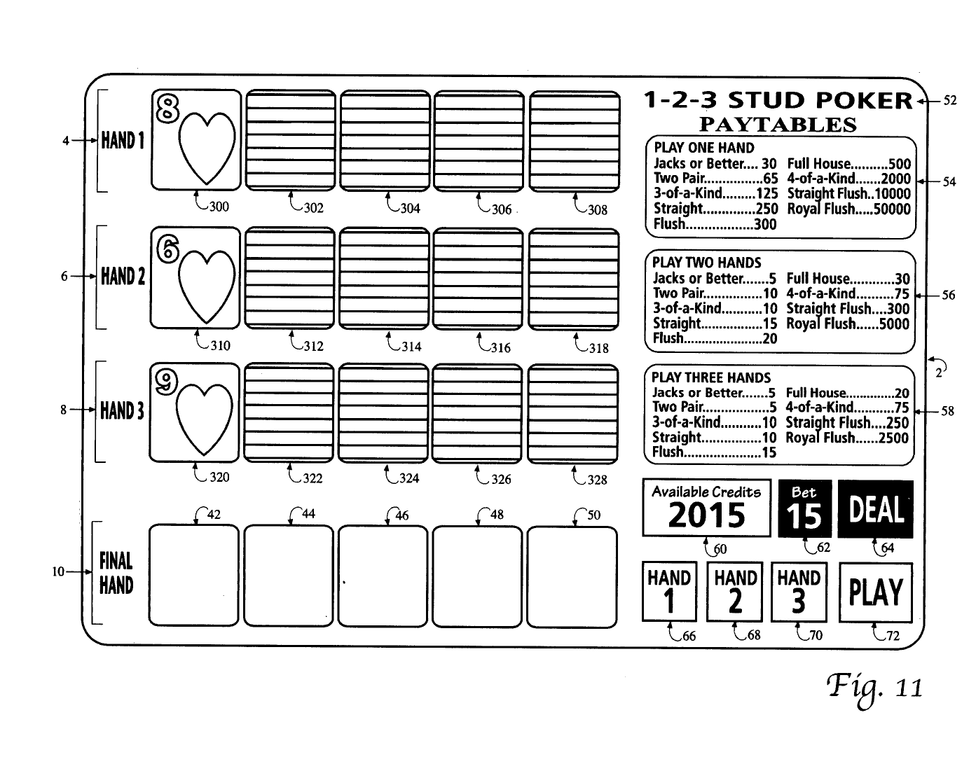

FIG. 11 refers to the elements in FIG. 1 with the available credits of FIG. 10, the player wagering 15 credits 62 and pressing deal 64 in order to play a separate subsequent game. The player's available credits have now been decremented to 2015 credits 60. Three 5-card hands are then dealt: Hand 1 comprises a first face-up card, the 8 of Hearts 300, and four face-down cards (302, 304, 306, 308). Hand 2 comprises a first face-up card, the 6 of Hearts 310, and four face-down cards (312, 314, 316, 318). Hand 3 comprises a first face-up card, the 9 of Hearts 320, and four face-down cards (322, 324, 326, 328).

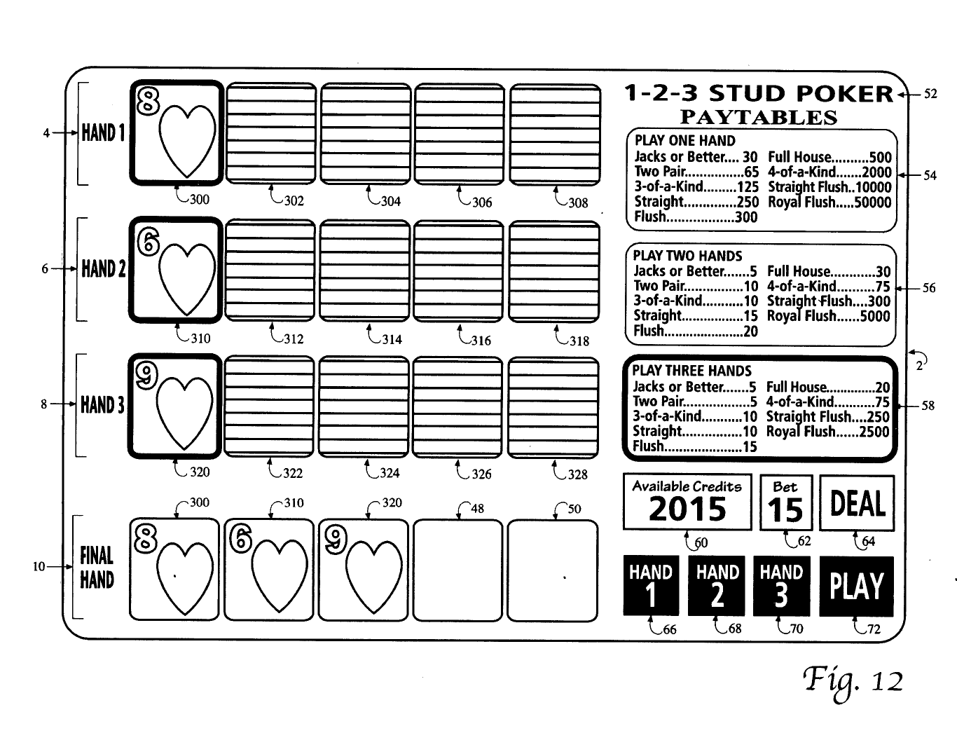

FIG. 12 refers to the elements in FIG. 11 with the player electing to play Hand 1 66 and Hand 2 68 and Hand 3 70, and pressing the Play button 72 to lock in his choice. Since the up cards in the selected hands provide three Hearts, the player is hoping that the final hand may result in a winning hand of at least a Flush, but with the chance of winning for a Straight Flush. (Achieving Jacks or Better or Two Pair would also be possible, depending on the revealed down cards.) The up card 300 in Hand 1 is then transferred to the final hand 10. The up card 310 in Hand 2 is also transferred to the final hand. The up card 320 in Hand 3 is also transferred to the final hand. The paytable for playing three hands 58 is then highlighted.

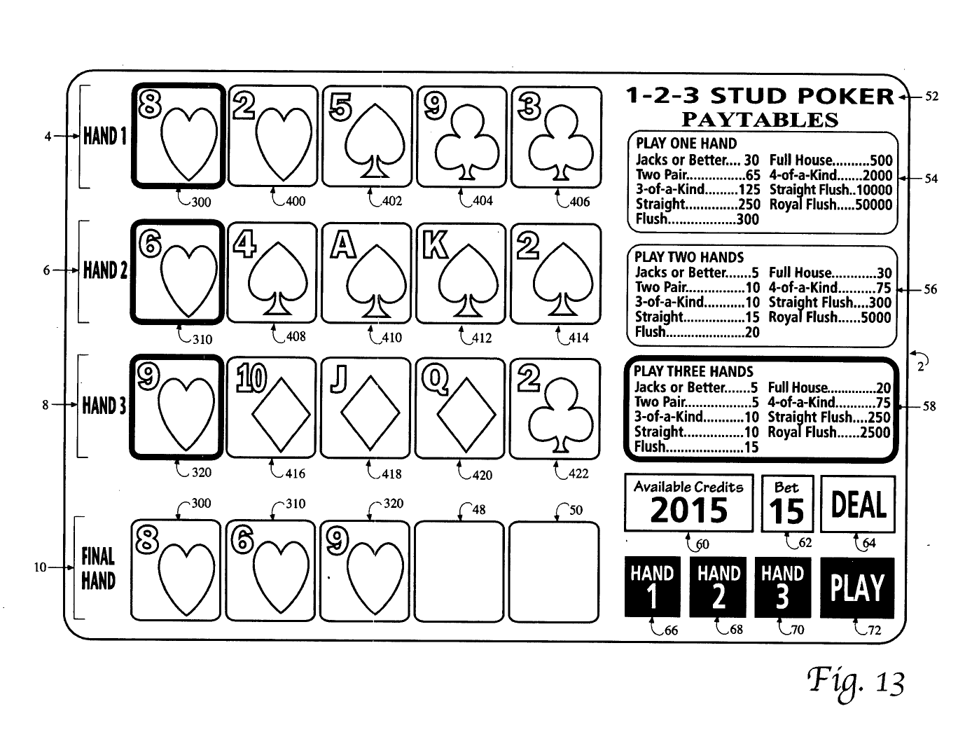

FIG. 13 refers to the elements in FIG. 12, with the face-down cards in Hand 1 being revealed (400, 402, 404, 406), the face-down cards in Hand 2 being revealed (408, 410, 412, 414) and the face-down cards in Hand 3 being revealed (416, 418, 420, 422).

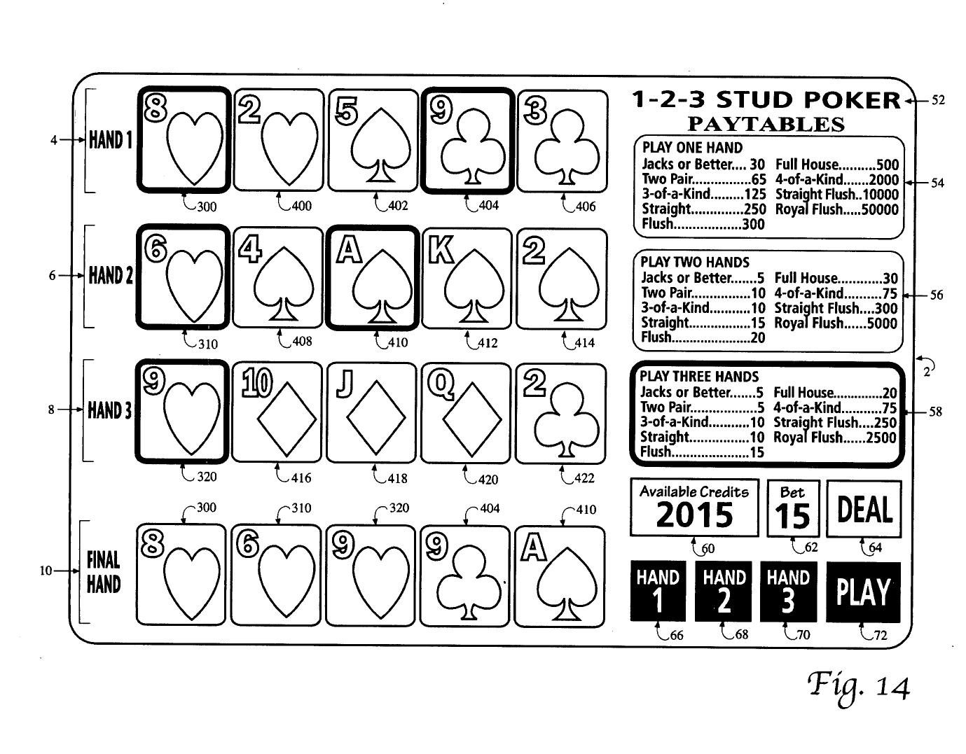

FIG. 14 refers to the elements in FIG. 13, with the two most optimal cards to complete the final hand being highlighted: the 9 of Clubs 404, and the Ace of Spades 410. (Note that in this example, no combinations of revealed cards would provide a winning final hand.) These same two cards are then transferred to the final hand.

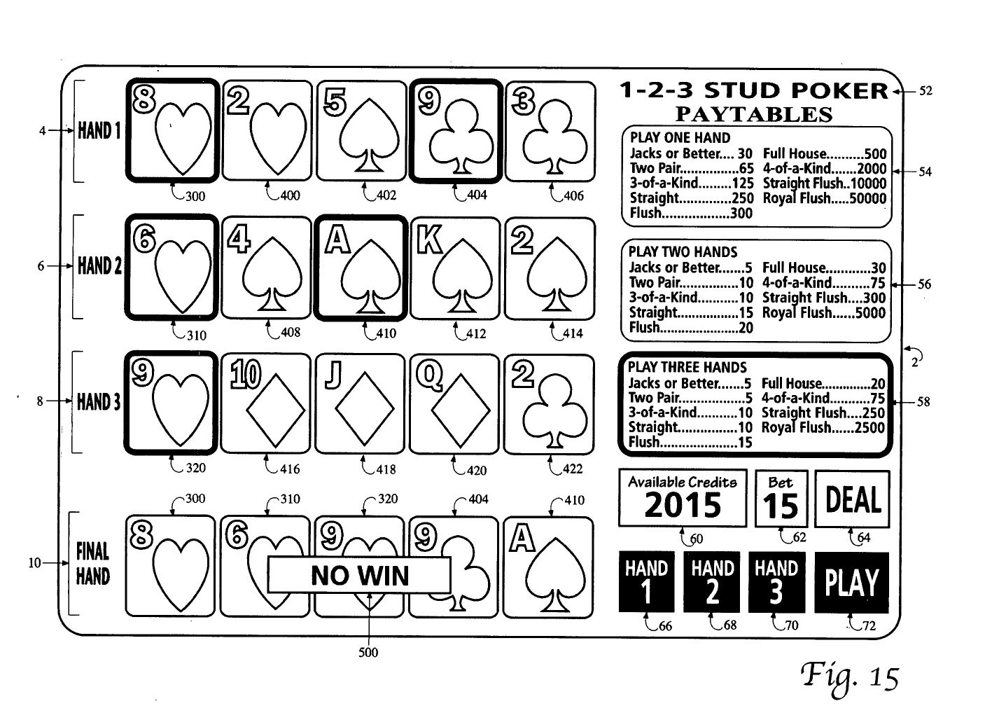

FIG. 15 refers to the elements in FIG. 14 with the final hand comprising no wins. According to the highlighted paytable 58, the final hand is worth 0 credits, as is shown in area 500. The no credits are then added to the player's available credits 60, which remain at 2015 credits.

Although specific examples and specific paytables have been provided in this discussion, these specifics are intended to be only support for the generic concepts of the invention and are not intended to be absolute limits in the scope of the technology discussed.

What is claimed:

1. A gaming system comprising: at least one processor; a gaming apparatus having at least one input device and at least one display device; at least one memory device which stores a plurality of instructions which, when executed by the at least one processor, cause the at leak one processor to operate with the at least one display device and the at least one input device to:
a) establish three separate predetermined paytables associated with a final five-card poker hand ranking;
b) establish an initial deck of playing cards to be used in the play of the poker game;
c) enable the player, using at least one input device, to make at least one wager on a five card poker hand;
d) upon recognition of the wager(s), distribute three separate playable five-card hands into three separate hand areas on the display device;
e) display each playable five-card hand as having one face-up card and four face-down cards;
f) provide a separate five-card final hand area on the display device;
g) enable the player to select to play any one, two, or three of the playable hands;
h) upon selection of the one, two, or three hands, transfer the face-up cards in the said selected hand(s) into the final hand area;
i) reveal the face-down cards in the selected hand(s);
j) determine by employing an optimum expected value function which revealed cards to transfer into the final hand in order to complete the final five-card hand;
k) transfer the said determined revealed cards into the final hand;
l) determine if the final hand is either a win or a loss; and
m) resolve the wager according to one of the three predetermined paytables.

2. The method of claim 1 wherein the initial deck includes Jokers or Wild Cards.

3. The method of claim 1 wherein the initial deck does not include Jokers or Wild Cards.

4. The method of claim 1 wherein each separate paytable is dependent upon the amount of playable hands selected.

5. The method of claim 4 wherein the paytable for selecting to play one hand provides higher pays than the paytable for selecting to play two hands and the paytable for selecting to play two hands provides higher pays than the paytable for selecting to play three hands.
